(19) United States
(12) Patent Application Publication
(10) Pub. No.: US 2018/0097389 A1
(43) Pub. Date: Apr. 5, 2018

(54) ELECTRONIC APPARATUS, METHOD FOR CONTROLLING THE SAME, AND CONTROL SYSTEM

(71) Applicant: FUJITSU LIMITED, Kawasaki-shi (JP)

(72) Inventor: Kazuaki Oishi, Yokohama (JP)

(73) Assignee: FUJITSU LIMITED, Kawasaki-shi (JP)

(21) Appl. No.: 15/711,263

(22) Filed: Sep. 21, 2017

(30) Foreign Application Priority Data
Oct. 5, 2016 (JP) 2016-197436

(51) Int. Cl. H02J 7/00

(52) U.S. Cl. CPC H02J 7/0068; H01M 2220/30; H02J 7/0004

(57) ABSTRACT

An electronic apparatus includes: a load; a first battery; a second battery; and a power supply control circuit configured to couple the first battery and the second battery to the load, wherein the power supply control circuit includes: a first switch including one end coupled to the first battery and the other end coupled to the load; a second switch including one end coupled to the second battery and the other end coupled to the load; and a first comparison circuit including a first input terminal coupled to an output terminal of the first battery and a second input terminal coupled to a threshold voltage and configured to control the first switch and the second switch based on a comparison result of an output voltage of the first battery and the threshold voltage and output a first battery selection signal indicating whether the first battery powers the load.

### CROSS-REFERENCE TO RELATED APPLICATION

This application is based upon and claims the benefit of priority of the prior Japanese Patent Application No. 2016-197436, filed on Oct. 5, 2016, the entire contents of which are incorporated herein by reference.

### FIELD

The embodiments discussed herein are related to an electronic apparatus, a method for controlling the same, and a control system.

### BACKGROUND

For example, a wireless communication apparatus includes a main battery and a sub-battery.

Related art techniques are disclosed in Japanese Laid-open Patent Publication No. 5-7175 and Japanese Laid-open Patent Publication No. 2004-40477.

### SUMMARY

According to an aspect of the invention, an electronic apparatus includes: a load; a first battery; a second battery; and a power supply control circuit configured to couple the first battery and the second battery to the load, wherein the power supply control circuit includes: a first switch including one end coupled to the first battery and the other end coupled to the load; a second switch including one end coupled to the second battery and the other end coupled to the load; and a first comparison circuit including a first input terminal coupled to an output terminal of the first battery and a second input terminal coupled to a threshold voltage and configured to control the first switch and the second switch based on a comparison result of an output voltage of the first battery and the threshold voltage and output a first battery selection signal indicating whether the first battery powers the load.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a control system including electronic apparatuses;

FIG. 2 illustrates an example of a power supply control circuit;

FIG. 3A illustrates an example of a timing chart of the power supply control circuit;

FIG. 3B illustrates an example of the power supply control circuit in a state where a first battery has an output voltage greater than or equal to a threshold voltage;

FIG. 3C illustrates an example of the power supply control circuit in a state where the first battery has an output voltage less than the threshold voltage;

FIG. 4 illustrates an example of a control system including electronic apparatuses;

FIG. 5 illustrates an example of a power supply control circuit;

FIG. 6A illustrates an example of the power supply control circuit in a state where a first battery has an output voltage greater than or equal to a threshold voltage;

FIG. 6B illustrates an example of the power supply control circuit in a state where the first battery has an output voltage less than the threshold voltage;

FIG. 7 illustrates an example of a control system including electronic apparatuses;

FIG. 8 illustrates an example of a power supply control circuit;

FIG. 9 illustrates an example of a timing chart of the power supply control circuit;

FIG. 10 illustrates an example of an operating state of the power supply control circuit;

FIG. 11 illustrates an example of an operating state of the power supply control circuit;

FIG. 12 illustrates an example of an operating state of the power supply control circuit;

FIG. 13 illustrates an example of a control system including electronic apparatuses;

FIG. 14 illustrates an example of a power supply control circuit; and

FIG. 15 illustrates an example of a control system including electronic apparatuses.

### DESCRIPTION OF EMBODIMENTS

In a wireless communication apparatus including a main battery and a sub-battery, for example, the battery for powering loads automatically switches from the main battery to the sub-battery when the voltage level of the main battery falls. For example, when the remaining power level of a power supply battery of a cellular telephone has reached or fallen below a certain value, a mail message indicating that the battery of the cellular telephone has been depleted is transmitted from the cellular telephone to a mail destination registered in advance.

For example, an increase in the circuit scale of a power supply control circuit, in which switching between batteries is performed in accordance with the detected remaining power level of a battery, results in an increase in power consumed in the power supply control circuit.

For example, an electronic apparatus including a power supply control circuit may be provided which has a relatively small circuit scale and in which switching between batteries is performed in accordance with the remaining power level of a battery.

For example, in an electronic apparatus, switching processing between a first battery and a second battery is performed by a power supply control circuit including a first switch, a second switch, and a first comparison circuit. Since the power supply control circuit includes the first switch, the second switch, and the first comparison circuit, the power consumed in the power supply control circuit is relatively small and thus the lifetimes of batteries in the electronic apparatus equipped with the power supply control circuit may be extended.

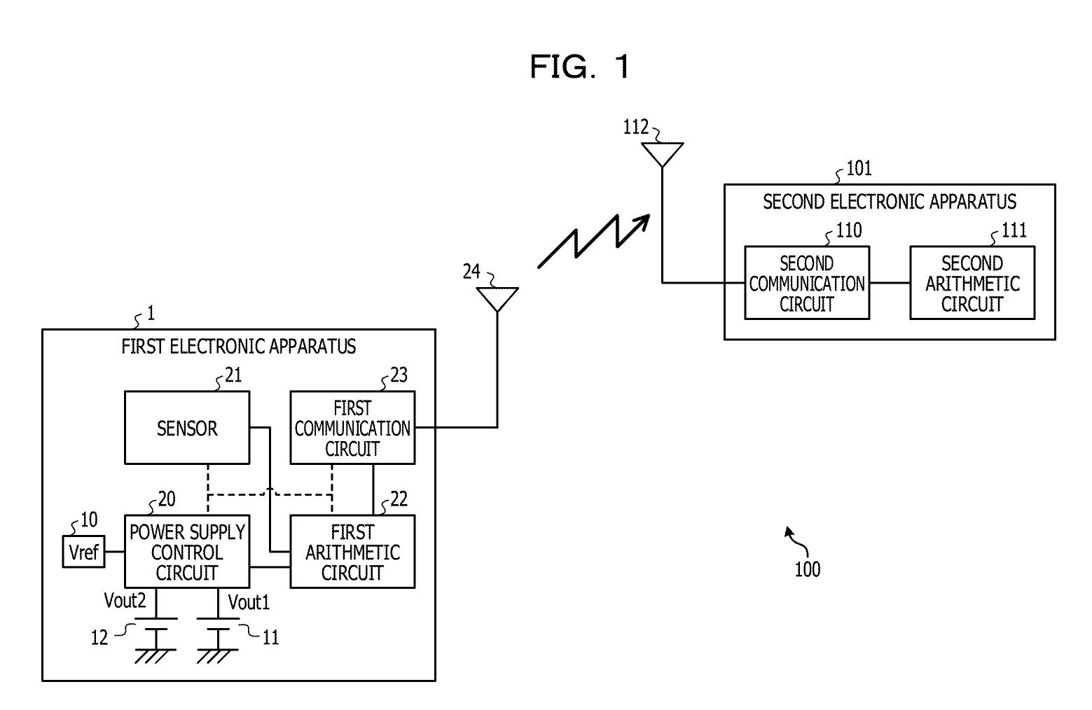

FIG. 1 illustrates an example of a control system including electronic apparatuses. In FIG. 1, signal lines are represented by solid lines and power supply lines are represented by broken lines.

A control system 100 includes a first electronic apparatus 1 and a second electronic apparatus 101. Although the single first electronic apparatus 1 is illustrated in the control system 100 in FIG. 1, a control system may include a plurality of first electronic apparatuses 1. By way of example, in the control system 100, the second electronic apparatus 101 is set as a hub (parent unit), a single or a plurality of first electronic apparatuses are set as terminal devices (child units), and the second electronic apparatus 101 collects a single or a plurality of pieces of detection data provided by the first electronic apparatuses 1.

The first electronic apparatus 1 includes a threshold voltage generation circuit 10, a first battery 11, a second battery 12, a power supply control circuit 20, a sensor 21, a first arithmetic circuit 22, and a first communication circuit 23 and transmits detection data, which is provided by the sensor 21, to the second electronic apparatus 101. The first battery 11 and the second battery 12, each in turn, supply power supply voltages via the power supply control circuit 20 to loads such as the sensor 21, the first arithmetic circuit 22, and the first communication circuit 23. The output voltage of the first battery 11 is Vout1 and the output voltage of the second battery 12 is Vout2. The second battery 12 may have a smaller capacity than the first battery 11. The threshold voltage generation circuit 10 is, by way of example, a bandgap type voltage source circuit, and generates a threshold voltage Vref and outputs the generated threshold voltage Vref to the power supply control circuit 20. By way of example, the power supply voltage of the threshold voltage generation circuit 10 is the output voltage Vout2 of the second battery 12.

The power supply control circuit 20 compares the output voltage Vout1 of the first battery 11 with the threshold voltage Vref, and switches the battery for supplying power supply voltages to loads from the first battery 11 to the second battery 12 based on the comparison result. The power supply control circuit 20 supplies power supply voltages from the first battery 11 to loads and outputs a first battery selection signal indicating that the first battery 11 powers the loads to the first arithmetic circuit 22, when the first battery 11 has an output voltage greater than or equal to the threshold voltage Vref. The power supply control circuit 20 supplies power supply voltages from the second battery 12 to loads and outputs a second battery selection signal indicating that the second battery 12 powers the loads to the first arithmetic circuit 22, when the first battery 11 has an output voltage less than the threshold voltage Vref.

The sensor 21 detects a certain physical quantity and outputs detection data representing the detected physical quantity to the first arithmetic circuit 22. The single sensor 21 is illustrated in the control system 100; however, a first electronic apparatus in a control system may include a plurality of sensors 21. The first arithmetic circuit 22 generates communication data including the first battery selection signal or the second battery selection signal input from the power supply control circuit 20 and detection data input from the sensor 21, and outputs the communication data to the first communication circuit 23. The first communication circuit 23 modulates the communication data input from the first arithmetic circuit 22 and transmits the modulated communication data via an antenna 24 to the second electronic apparatus 101.

The second electronic apparatus 101 is disposed separately from the first electronic apparatus 1, and includes a second communication circuit 110 and a second arithmetic circuit 111. The second communication circuit 110 receives communication data transmitted from the first communication circuit 23 via an antenna 112, demodulates the received communication data, and outputs the demodulated communication data to the second arithmetic circuit 111. The second arithmetic circuit 111 extracts a first battery selection signal or a second battery selection signal and detection data from the communication data. When the first battery selection signal is extracted, the second arithmetic circuit 111 may notify the operator that the first battery 11 is supplying power supply voltages to loads in the first electronic apparatus 1, by using a display device or the like. When the second battery selection signal is extracted, the second arithmetic circuit 111 may notify the operator that the second battery 12 is supplying power supply voltages to loads in the first electronic apparatus 1, by using a display device or the like.

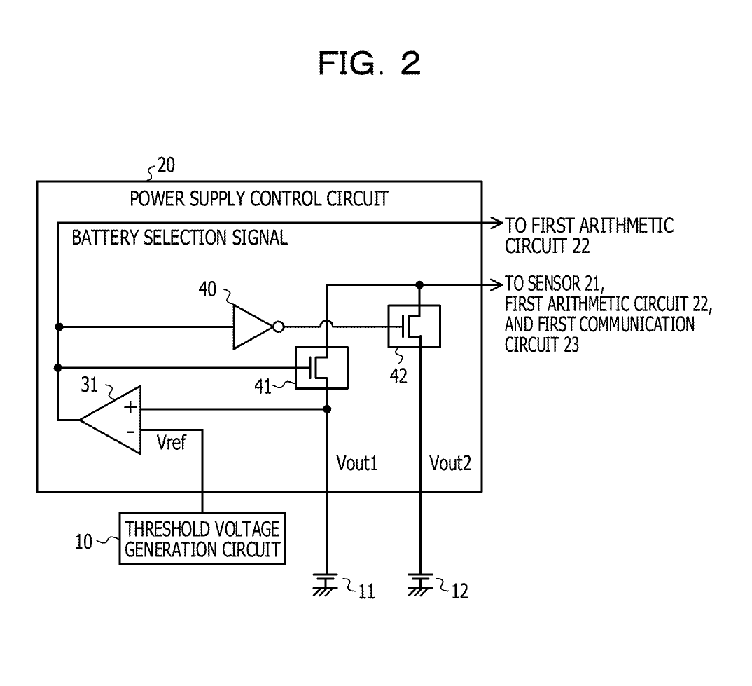

FIG. 2 illustrates an example of a power supply control circuit. The power supply control circuit illustrated in FIG. 2 may be the power supply control circuit illustrated in FIG. 1.

The power supply control circuit 20 includes a first comparison circuit 31, an inversion element 40, a first switch 41, and a second switch 42. Power supply voltages are supplied, by way of example, from the second battery 12 via power supply lines to the first comparison circuit 31 and the inversion element 40. The first comparison circuit 31 includes a first input terminal coupled to an output terminal of the first battery 11, and a second input terminal to which the threshold voltage Vref is input. The first comparison circuit 31 controls the first switch 41 and the second switch 42 and outputs a battery selection signal indicating whether or not the first battery 11 powers loads, based on a comparison result between the output voltage Vout1 of the first battery 11 and the threshold voltage Vref.

For example, the first comparison circuit 31 turns the first switch 41 on and the second switch 42 off and outputs a first battery selection signal indicating that the first battery 11 powers loads, when the output voltage Vout1 of the first battery 11 is greater than or equal to the threshold voltage Vref. The signal value corresponding to the first battery selection signal may be “1”, by way of example. The first comparison circuit 31 turns the first switch 41 off and the second switch 42 on and outputs a second battery selection signal indicating that the second battery 12 powers loads, when the output voltage Vout1 of the first battery 11 is less than the threshold voltage Vref. The signal value corresponding to the second battery selection signal may be “0”, by way of example.

The inversion element 40 inverts the first battery selection signal or the second battery selection signal input from the first comparison circuit 31 and outputs the inverted signal to the second switch 42.

The first switch 41 and the second switch 42 may be metal-oxide-silicon field-effect transistors (MOSFETs), by way of example. The gate of the first switch 41 is coupled to an output terminal of the first comparison circuit 31, the source of the first switch 41 is coupled to the output terminal of the first battery 11, and the drain of the first switch 41 is coupled to loads such as the sensor 21, the first arithmetic circuit 22, and the first communication circuit 23. The gate of the second switch 42 is coupled to an output terminal of the inverse element 40, the source of the second switch 42 is coupled to an output terminal of the second battery 12, and the drain of the second switch 42 is coupled, together with the drain of the first switch 41, to the loads.

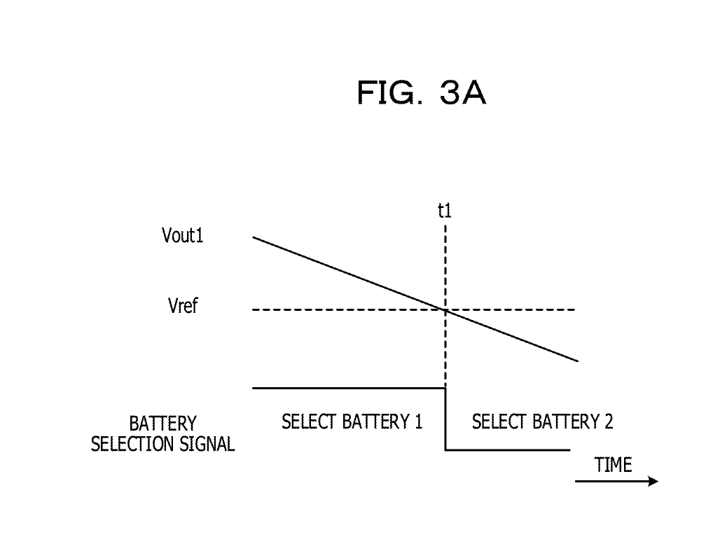

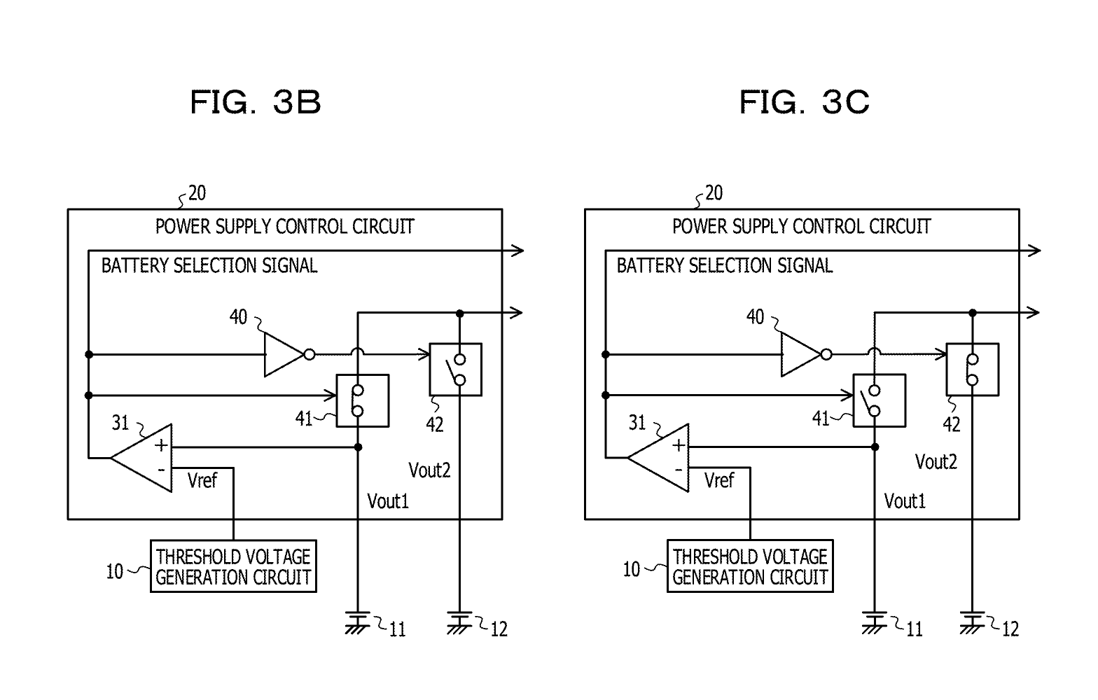

FIG. 3A illustrates an example of a timing chart of a power supply control circuit. FIG. 3B illustrates an example of the power supply control circuit in a state where the output voltage Vout1 of the first battery 11 is greater than or equal to the threshold voltage Vref. FIG. 3C illustrates an example of the power supply control circuit in a state where the output voltage Vout1 of the first battery 11 is less than the threshold voltage Vref. With reference to FIGS. 3A to 3C, operations of the power supply control circuit 20 illustrated in FIG. 2 will be described.

When implemented as an NMOSFET device, the first switch 41 is turned on, supplying the output voltage Vout1 of the first battery 11 to loads, for example, by input of a first battery selection signal representing a signal value “1” to the gate when the first battery 11 has an output voltage greater than or equal to the threshold voltage Vref. When the first battery 11 has an output voltage greater than or equal to the threshold voltage Vref, the second switch 42 is turned off, for example, by input of the inverse of a second battery selection signal representing a signal value “0” via the inversion element 40 to the gate. The first switch 41 may be a PMOSFET.

When the output voltage of the first battery 11 falls below the threshold voltage Vref at a time t1 as illustrated in FIG. 3A, the first switch 41 is turned off by input of a first battery selection signal representing the signal value “0” to the gate. The second switch 42 is turned on, supplying the output voltage Vout2 of the second battery 12 to loads, by input of the inverse of a second battery selection signal representing the signal value “1” via the inversion element 40 to the gate.

In the first electronic apparatus 1, the power supply control circuit 20, which switches the battery for supplying power supply voltages to loads from the first battery 11 to the second battery 12, includes the first comparison circuit 31, the inversion element 40, the first switch 41, and the second switch 42. Owing to the inclusion of the first comparison circuit 31, the inversion element 40, the first switch 41, and the second switch 42, the electronic apparatus 1 may be provided with a battery switching circuit whose circuit scale is relatively small.

The first electronic apparatus 1 transmits either of a first battery selection signal and a second battery selection signal, which indicate that the first battery 11 supplies power supply voltages to loads and that the second battery 12 supplies power supply voltages to loads, respectively, to the second electronic apparatus 101 disposed separately from the first electronic apparatus 1. For example, being notified by the second electronic apparatus 101 that the second battery 12 is supplying power supply voltages to loads in the first electronic apparatus 1, the operator may learn that the first battery 11 is exhausted, without having to visit a location where the first electronic apparatus 1 is placed.

In the first electronic apparatus 1, the second battery 12 is used as an auxiliary battery having a smaller capacity than the first battery 11. This may reduce the total cost of batteries mounted in the first electronic apparatus 1.

In the first electronic apparatus 1, when the threshold voltage generation circuit 10 generates the threshold voltage Vref from the output voltage Vout2 of the second battery 12, the threshold voltage generation circuit 10 may also generate the given threshold voltage Vref after the output voltage of the first battery 11 falls.

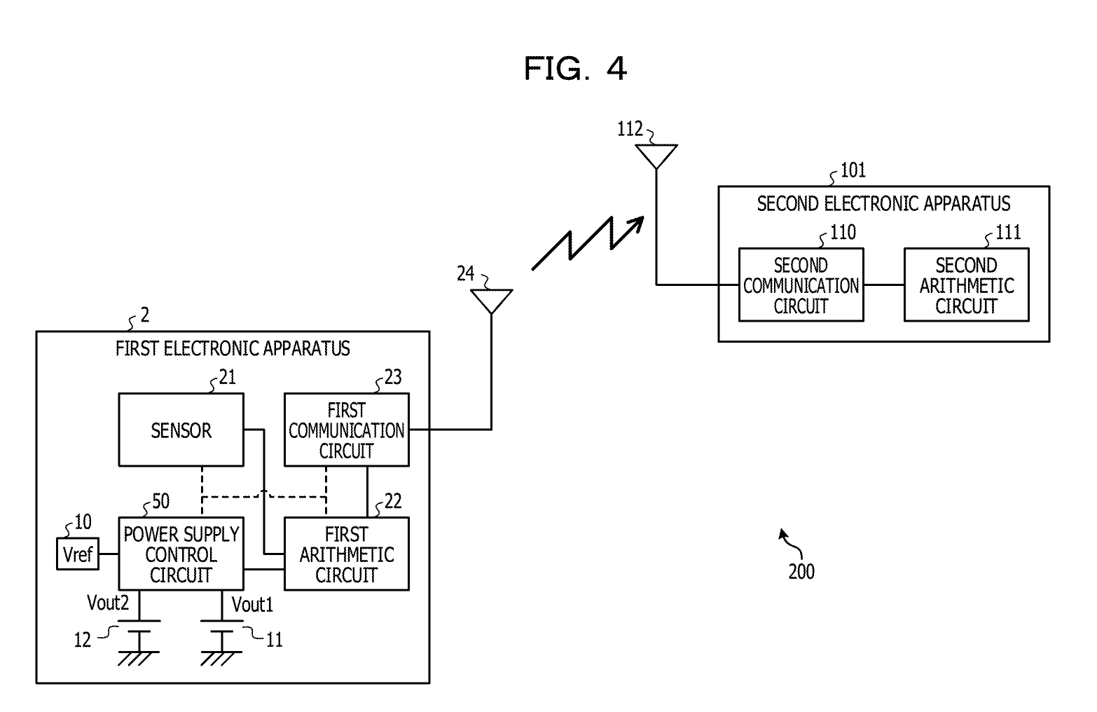

FIG. 4 illustrates an example of a control system including electronic apparatuses. In FIG. 4, signal lines are represented by solid lines and power supply lines are represented by broken lines.

A control system 200 differs from the control system 100 in that a first electrode apparatus 2 is provided instead of the first electrode apparatus 1. The first electronic apparatus 2 differs from the first electronic apparatus 1 in that the first electronic apparatus 2 includes a power supply control circuit 50 instead of the power supply control circuit 20. With reference to FIG. 4, the configurations and functions of components of the control system 200 other than the power supply control circuit 50 may be substantially the same as or similar to the configurations and functions of components of the control system 100 denoted by the same reference letters, and detailed description thereof may be omitted.

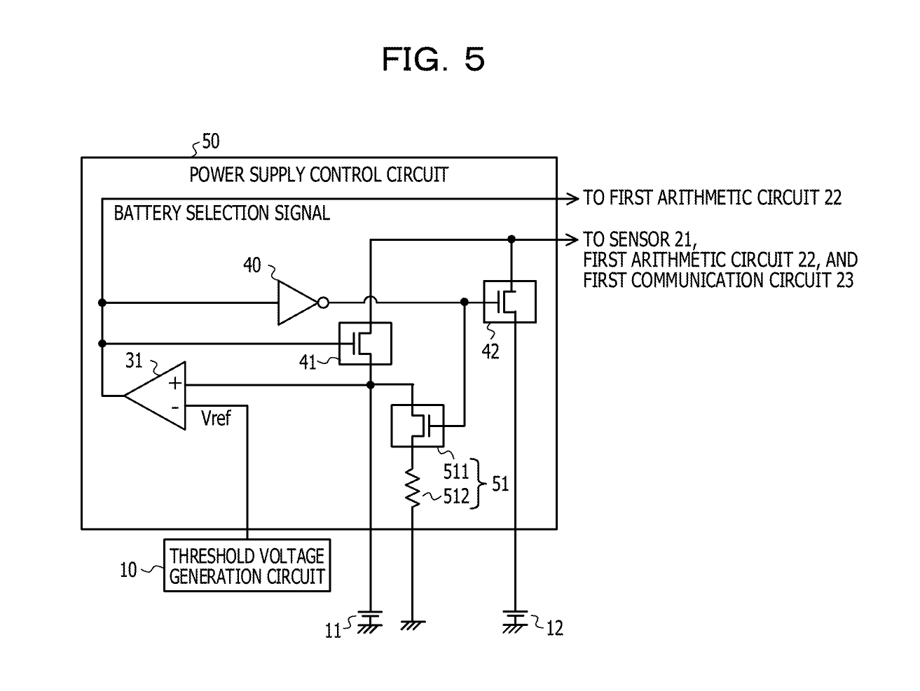

FIG. 5 illustrates an example of a power supply control circuit. The power supply control circuit illustrated in FIG. 5 may be the power supply control circuit illustrated in FIG. 4.

The power supply control circuit 50 differs from the power supply control circuit 20 in that the power supply control circuit 50 includes a first ground circuit 51 made up of a first ground switch 511 and a first ground resistor 512 coupled in series. The configurations and functions of components of the power supply control circuit 50 other than the first ground circuit 51 illustrated in FIG. 5 may be substantially the same as or similar to the configurations and functions of components of the power supply control circuit 20 denoted by the same reference letters, and detailed description thereof may be omitted.

The first ground switch 511 may be a MOSFET, by way of example. The gate of the first ground switch 511 is coupled to the output terminal of the inverse element 40, the source of the first ground switch 511 is coupled to one end of the first ground resistor 512, and the drain of the first ground switch 511 is coupled to the output terminal of the first battery 11. The other end of the first ground resistor 512 is grounded. A first inversion battery selection signal, which is the inverse of a first battery selection signal, and a second inversion battery selection signal, which is the inverse of a second battery selection signal, are input to the gate of the first ground switch 511.

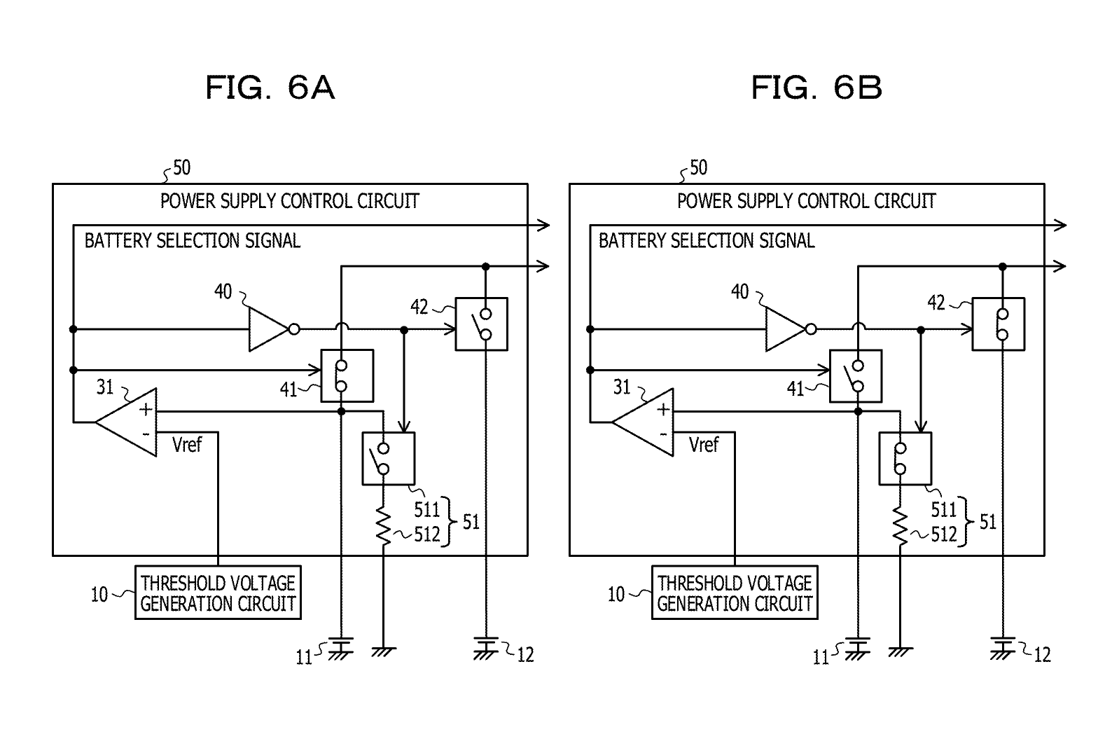

FIGS. 6A and 6B are drawings for explaining operations of the power supply control circuit 50. FIG. 6A illustrates an example of a power supply control circuit in a state where the output voltage Vout1 of the first battery 11 is greater than or equal to the threshold voltage Vref. FIG. 6B illustrates an example of the power supply control circuit in a state where the output voltage Vout1 of the first battery 11 is less than the threshold voltage Vref.

When implemented as an NMOSFET device, the first ground switch 511 is turned off, for example, when a first inversion battery selection signal representing the signal value “0” is input via the inversion element 40 to the gate. The first ground switch 511 is turned on, grounding the output terminal of the first battery 11, for example, when a first inversion battery selection signal representing the signal value “1” is input via the inversion element 40 to the gate. The first ground switch 511 may be a PMOSFET. In this case, the first ground switch 511 is turned off when the first inversion battery selection signal representing the signal value “1” is input and the first ground switch 511 is turned on when the first inversion battery selection signal representing the signal value “0” is input.

In the first electronic apparatus 2, the power supply control circuit 50 grounds the output terminal of the first battery 11 when the second battery 12 supplies power supply voltages to loads. This may reduce the occurrence of cases where the output voltage Vout1 of the first battery 11 rises again when the first battery 11 does not supply power supply voltages to loads. In the first electronic apparatus 2, since the output voltage Vout1 of the first battery 11 is inhibited from rising again when the second battery 12 supplies power supply voltages to loads, the comparison result of the first comparison circuit 31 may be inverted, causing the exhausted first battery 11 not to supply power supply voltages to loads.

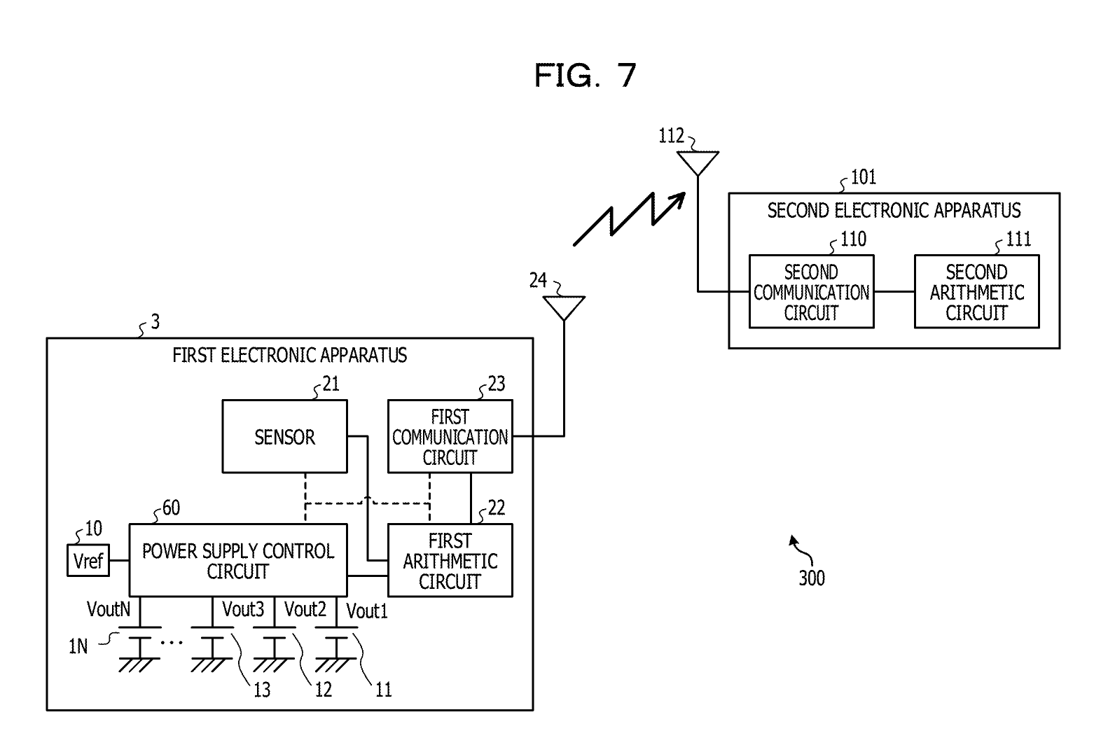

FIG. 7 illustrates an example of a control system including electronic apparatuses. In FIG. 7, signal line are represented by solid lines and power supply lines are represented by broken lines.

A control system 300 differs from the control system 100 illustrated in FIG. 1 in that a first electronic apparatus 3 is provided instead of the first electronic apparatus 1. The first electronic apparatus 3 differs from the first electronic apparatus 1 illustrated in FIG. 1 in that the first electronic apparatus 3 includes third to Nth batteries 13 to 1N in addition to the first battery 11 and the second battery 12. The first electronic apparatus 3 differs from the first electronic apparatus 1 illustrated in FIG. 1 in that the first electronic apparatus 3 includes a power supply control circuit 60 instead of the power supply control circuit 20. The configurations and functions of components of the control system 300 other than the third to Nth batteries 13 to 1N and the power supply control circuit 60 are substantially the same as or similar to the configurations and functions of components of the control system 100 denoted by the same reference letters, and therefore detailed description thereof may be omitted. The threshold voltage generation circuit 10 generates the threshold voltage Vref and outputs the generated threshold voltage Vref to the power supply control circuit 60.

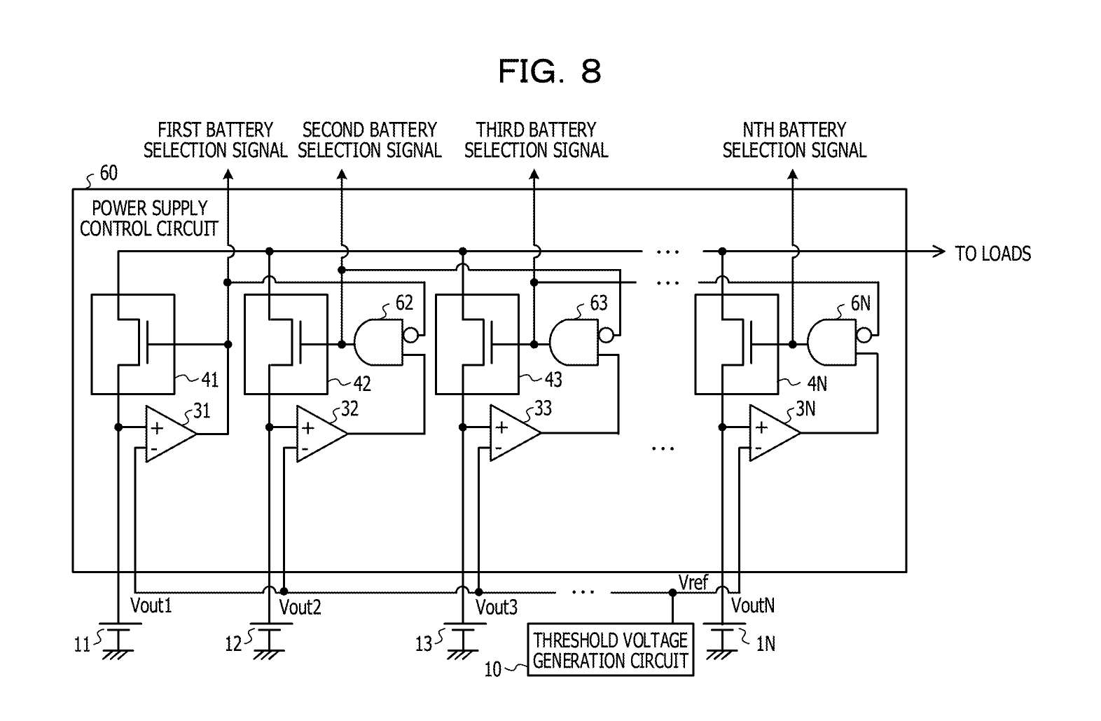

FIG. 8 illustrates an example of a power supply control circuit. The power supply control circuit illustrated in FIG. 8 may be the power supply control circuit illustrated in FIG. 7.

The power supply control circuit 60 differs from the power supply control circuit 20 illustrated in FIG. 2 in that the power supply control circuit 60 includes (N−1) comparison circuits from a second comparison circuit 32 to an Nth comparison circuit 3N in addition to the first comparison circuit 31. The power supply control circuit 60 differs from the power supply control circuit 20 illustrated in FIG. 2 in that the power supply control circuit 60 includes (N−2) switches from a third switch 43 to an Nth switch 4N in addition to the first switch 41 and the second switch 42. The power supply control circuit 60 differs from the power supply control circuit 20 illustrated in FIG. 2 in that the power supply control circuit 60 includes (N−1) switch control circuits from a second switch control circuit 62 to an Nth switch control circuit 6N instead of the inversion element 40.

Each of the second to Nth comparison circuits 32 to 3N includes a first input terminal coupled to an output terminal of an Mth battery 1M, M being an integer greater than or equal to two and less than or equal to N, and a second input terminal to which the threshold voltage Vref is input. Each of the second to Nth comparison circuits 32 to 3N outputs an Mth powerable signal, which indicates that the Mth battery 1M coupled to an Mth switch 4M is able to power loads, when the Mth battery 1M has an output voltage greater than or equal to the threshold voltage Vref. Each of the second to Nth comparison circuits 32 to 3N outputs an Mth non-powering signal, which indicates that the Mth battery 1M coupled to the Mth switch 4M does not power loads, when the Mth battery 1M has an output voltage less than the threshold voltage Vref. For example, the second comparison circuit 32 outputs a second powerable signal, which indicates that the second battery 12 is able to power loads, when the second battery 12 has an output voltage greater than or equal to the threshold voltage Vref. The second comparison circuit 32 outputs a second non-powering signal, which indicates that the second battery 12 does not power loads, when the second battery 12 has an output voltage less than the threshold voltage Vref.

Each of the third to Nth switches 43 to 4N includes one end coupled to the output terminal of a corresponding one of (N−2) batteries, from the third battery 13 to the Nth battery 1N, and the other end coupled to loads. For example, one end of the third switch 43 is coupled to an output terminal of the third battery 13, one end of the fourth switch 44 is coupled to an output terminal of the fourth battery 14, one ends of the other switches are coupled likewise, and one end of the Nth switch 4N is coupled to an output terminal of the Nth battery 1N.

Each of the second to Nth switch control circuits 62 to 6N is an AND element that computes the logical conjunction of the inverse of a first input signal input to a first input terminal thereof and a second input signal input to a second input terminal thereof. Each of the second to Nth switch control circuits 62 to 6N includes a first control terminal to which an output terminal of an (M−1)th comparison circuit 3(M−1) is coupled, and a second control terminal to which an output terminal of an Mth comparison circuit 3M is coupled. Each of the second to Nth switch control circuits 62 to 6N turns on the Mth switch 4M when the (M−1)th comparison circuit 3(M−1) outputs a non-powering signal and the Mth comparison circuit outputs a powerable signal. Each of the second to Nth switch control circuits 62 to 6N outputs an Mth battery selection signal, which indicates that the Mth battery 1M is selected, when the (M−1)th comparison circuit 3(M−1) outputs a non-powering signal and the Mth comparison circuit 3M outputs a powerable signal. For example, the second switch control circuit 62 turns on the second switch 42 and outputs a second battery selection signal, which indicates that the second battery 12 is selected, when the first comparison circuit 31 outputs a non-powering signal and the second comparison circuit 32 outputs a powerable signal.

Each of the second to Nth switch control circuits 62 to 6N turns off the Mth switch 4M when the (M−1)th comparison circuit 3(M−1) outputs a powerable signal and when the Mth comparison circuit 3M outputs a non-powering signal. For example, the second switch control circuit 62 turns off the second switch 42 when the first comparison circuit 31 outputs a powerable signal and when the second comparison circuit 32 outputs a non-powering signal.

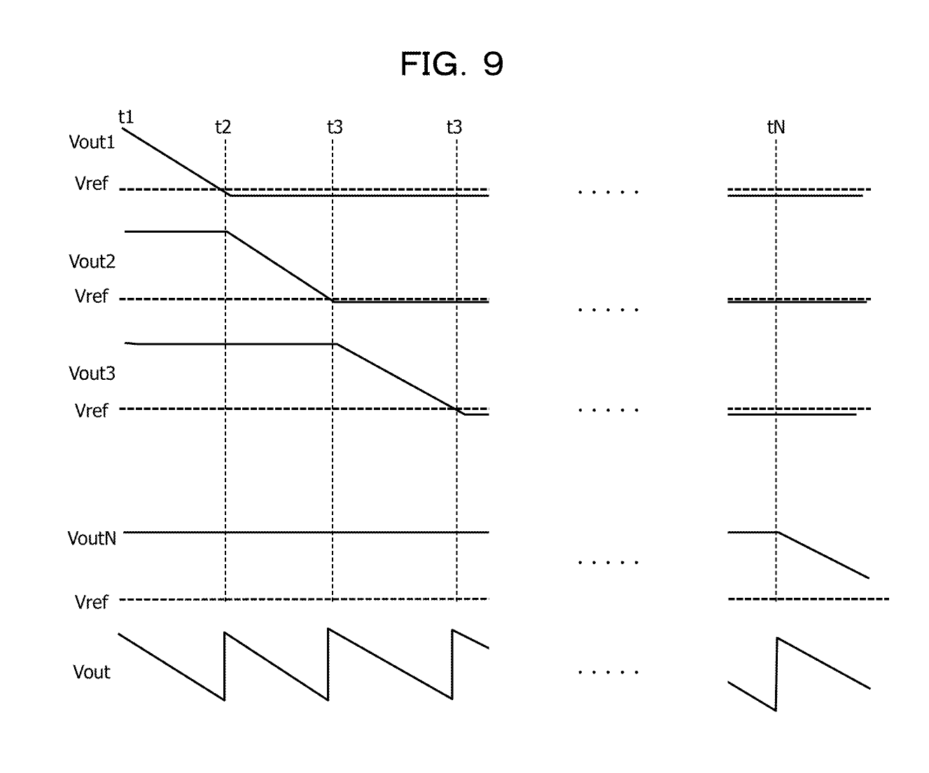

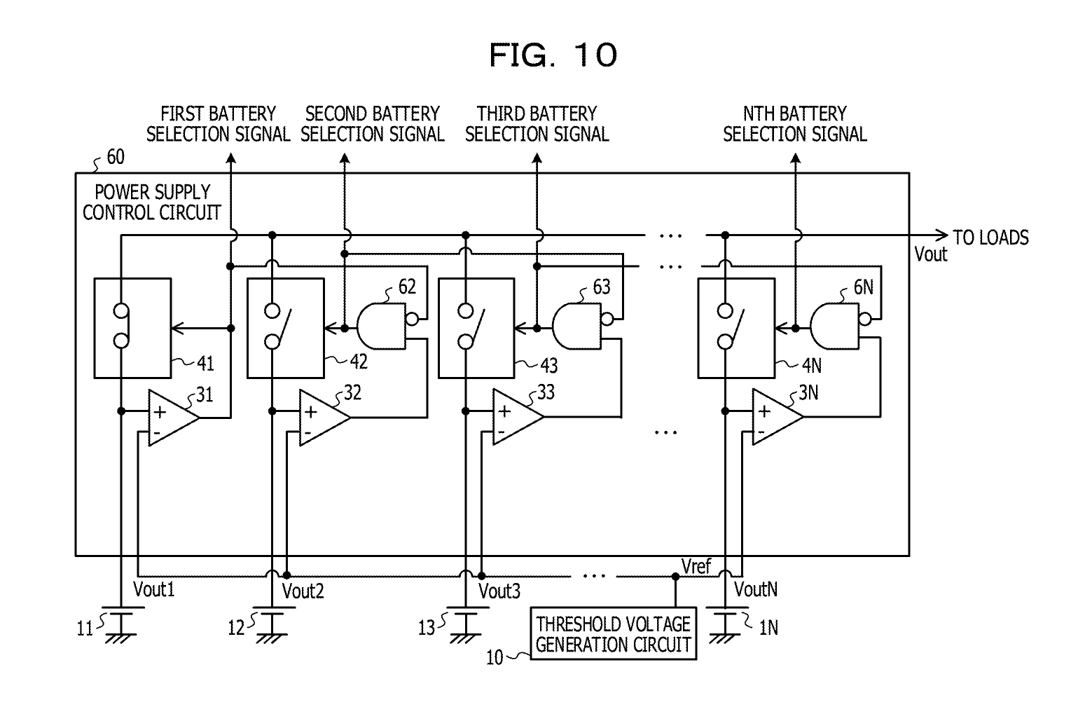

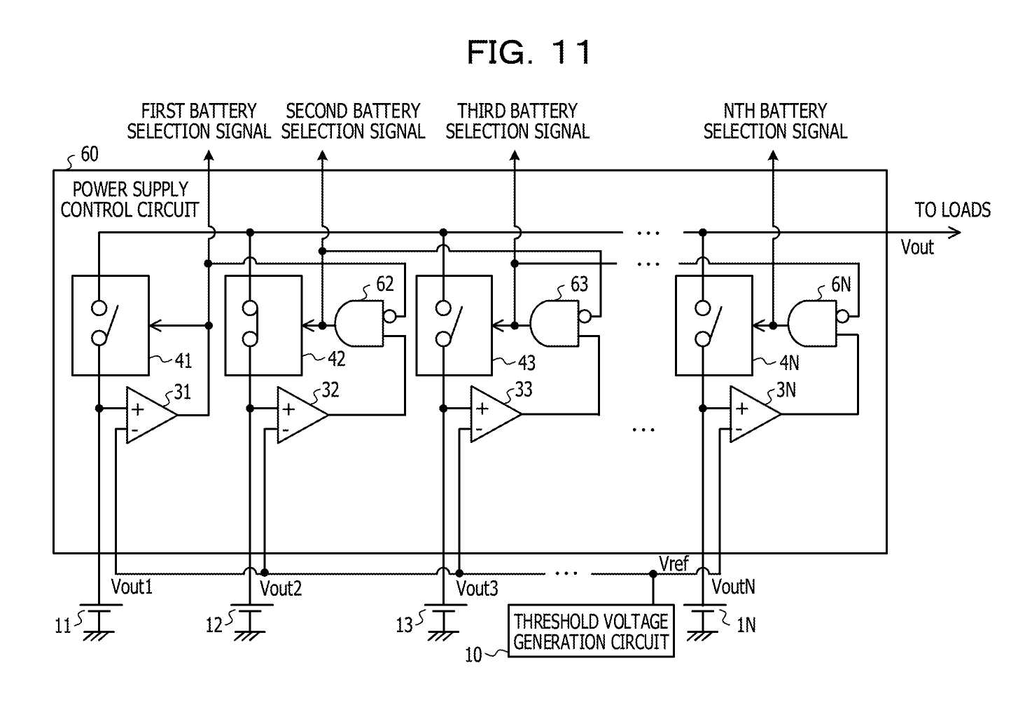

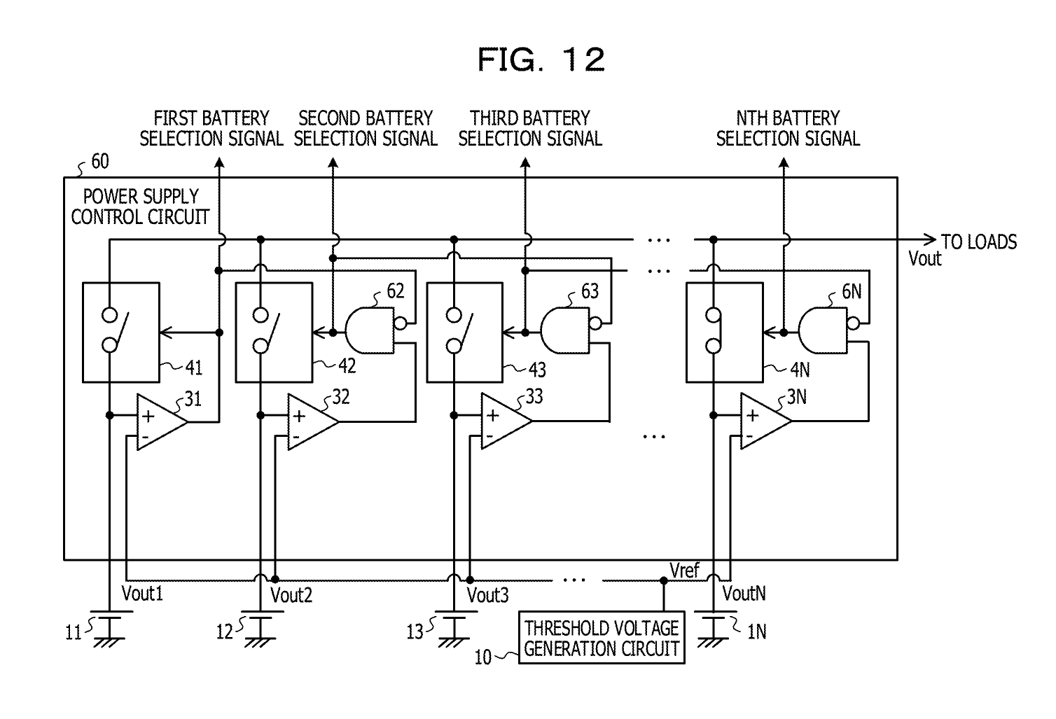

FIG. 9 illustrates an example of a timing chart of the power supply control circuit. The signal values illustrated in FIG. 9 are examples, and the signal values represented as “0” and “1” in FIG. 9 may be inverted. FIGS. 10 to 12 illustrate examples of operating states of the power supply control circuit. FIG. 10 illustrates an operating state of the power supply control circuit 60 at the time t1 illustrated in FIG. 9. FIG. 11 illustrates an operating state of the power supply control circuit 60 at a time t2 illustrated in FIG. 9. FIG. 12 illustrates an operating state of the power supply control circuit 60 at a time tN illustrated in FIG. 9.

At the time t1, as illustrated in FIG. 10, the first switch 41 is turned on and the second to Nth switches 42 to 4N are turned off, supplying power supply voltages from the first battery 11 to loads such as the sensor 21, the first arithmetic circuit 22, and the first communication circuit 23. From the time t1 to the time t2, the output voltage Vout1 of the first battery 11 gradually falls. During a period from the time t1 to the time t2, the signal value of a first battery selection signal is “1” and the signal values of second to Nth battery selection signals are “0”.

At the time t2, the output voltage Vout1 of the first battery 11 falls below the threshold voltage Vref. At the time t2, as illustrated in FIG. 11, the second switch 42 is turned on and the first switch 41 and the third to Nth switches 43 to 4N are turned off, supplying power supply voltages from the second battery 12 to loads such as the sensor 21, the first arithmetic circuit 22, and the first communication circuit 23. From the time t2 to a time t3, the output voltage Vout2 of the second battery 12 gradually falls. During a period from the time t2 to the time t3, the signal value of the second battery selection signal is “1” and the signal values of the first battery selection signal and the third to Nth battery selection signals are “0”.

Thereafter, likewise, the third to (N−1)th batteries 13 to 1(N−1), each in turn, supply power supply voltages to loads. At the time tN, the output voltage Vout (N−1) of the (N−1)th battery 1(N−1) falls below the threshold voltage Vref.

At the time tN, as illustrated in FIG. 12, the Nth switch 4N is turned on and the first to (N−1)th switches 41 to 4(N−1) are turned off, supplying power supply voltages from the Nth battery 1N to loads such as the sensor 21, the first arithmetic circuit 22, and the first communication circuit 23.

Since the first electronic apparatus 3 supplies power supply voltages from N batteries, each in turn, to loads and outputs battery selection signals indicating which of the N batteries supplies power supply voltages to the loads, the operator may accurately grasp the remaining power level of the batteries. For example, assuming that the first electronic apparatus 3 includes eight batteries, when the first electronic apparatus 3 outputs a battery selection signal indicating that the seventh battery supplies power supply voltages to the loads, the operator may understand that the power level corresponding to one eighth of the total capacity of all the batteries remains.

In the first electronic apparatus 3, when the threshold voltage generation circuit 10 generates the threshold voltage Vref, for example, from the output voltage VoutN of the Nth battery 1N, the threshold voltage generation circuit 10 may also generate the given threshold voltage Vref after the output voltages of batteries up to the (N−1)th battery fall.

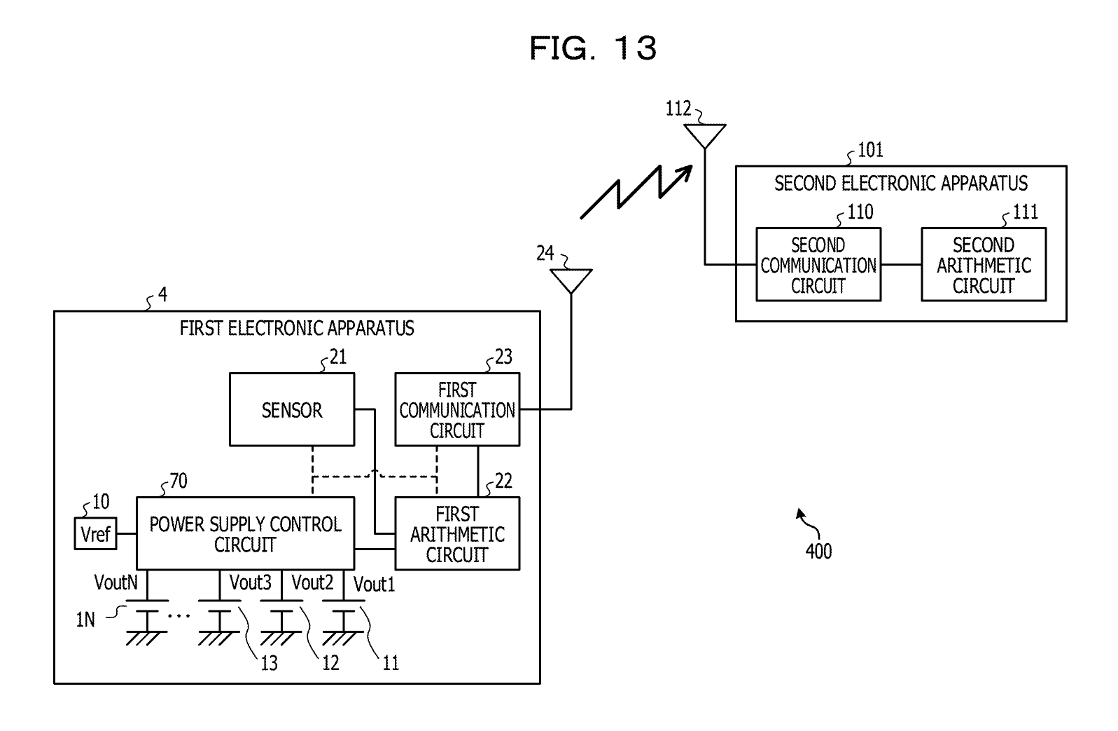

FIG. 13 illustrates an example of a control system including electronic apparatuses. In FIG. 13, signal lines are represented by solid lines and power supply lines are represented by broken lines.

A control system 400 differs from the control system 300 illustrated in FIG. 7 in that a first electronic apparatus 4 is provided instead of the first electronic apparatus 3. The first electronic apparatus 4 differs from the first electronic apparatus 3 in that the first electronic apparatus 4 includes a power supply control circuit 70 instead of the power supply control circuit 60. The configurations and functions of components of the control system 400 other than the power supply control circuit 70 are substantially the same as or similar to the configurations and functions of components of the control system 300 illustrated in FIG. 7 denoted by the same reference letters, and therefore detailed description thereof may be omitted.

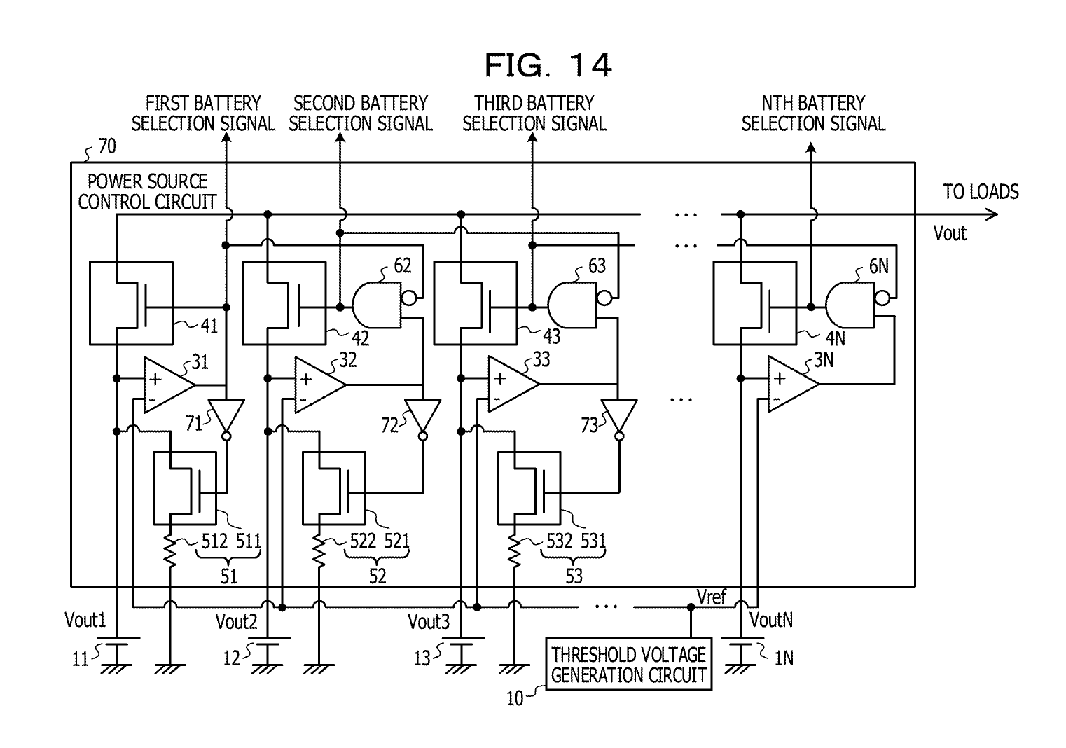

FIG. 14 illustrates an example of a power supply control circuit. The power supply control circuit illustrated in FIG. 14 may be the power supply control circuit illustrated in FIG. 13.

The power supply control circuit 70 differs from the power supply control circuit 60 in that the power supply control circuit 70 includes first to (N−1)th ground circuits 51 to 5(N−1) and first to (N−1)th inversion elements 71 to 7(N−1). The configurations and functions of components of the power supply control circuit 70 other than the first to (N−1)th ground circuits 51 to 5(N−1) and the first to (N−1)th inversion elements 71 to 7(N−1) may be substantially the same as or similar to the configurations and functions of components of the power supply control circuit 60 illustrated in FIG. 8 denoted by the same reference letters. Accordingly, detailed description of the configurations and functions of components of the power supply control circuit 70 other than the first to (N−1)th ground circuits 51 to 5(N−1) and the first to (N−1)th inversion elements 71 to 7(N−1) may be omitted.

Each of the first to (N−1)th ground circuits 51 to 5(N−1) includes a Qth ground switch 5Q1 and a Qth ground resistor 5Q2, Q being an integer less than or equal to (N−1). The Qth ground switch 5Q1 may be a MOSFET, by way of example. The gate of the Qth ground switch 5Q1 is coupled to an output terminal of a Qth inversion element 7Q, the source of the Qth ground switch 5Q1 is coupled to one end of the Qth ground resistor 5Q2, and the drain of the Qth ground switch 5Q1 is coupled to an output terminal of a Qth battery 1Q. The other end of the Qth ground resistor 5Q2 is grounded. The Qth ground circuit 5Q grounds the output terminal of the Qth battery 1Q when the Qth battery 1Q has an output voltage less than a threshold voltage. The Qth inversion element 7Q inverts a Qth powerable signal or a Qth non-powering signal input from the Qth comparison circuit 3Q and outputs the inverted signal to the gate of the Qth ground switch 5Q1. A Qth inverted powerable signal, which is the inverse of the Qth powerable signal, or a Qth inverted non-powering signal, which is the inverse of the Qth non-powering signal, is input to the gate of the Qth ground switch 5Q1.

When implemented as an NMOSFET device, the Qth ground switch 5Q1 is turned off, for example, when a Qth inverted powerable signal indicating the signal value “0” is input via the Qth inversion element 7Q to the gate. The Qth ground switch 5Q1 is turned on, grounding an output terminal of the Qth battery 1Q, for example, when a Qth inverted non-powering signal indicating the signal value “1” is input via the Qth inversion element 7Q to the gate. The Qth ground switch 5Q1 may be a PMOSFET. In this case, the Qth ground switch 5Q1 is turned off when the Qth inverted powerable signal indicating the signal value “1” is input and the Qth ground switch 5Q1 is turned on when the Qth inverted non-powering signal indicating the signal value “0” is input.

In the first electronic apparatus 4, the power supply control circuit 70 grounds an output terminal of a battery in question when the output voltage of the battery falls below a threshold voltage, and thus may reduce variations in the output voltage of the battery whose voltage has fallen. Since the output voltage of a battery whose voltage has fallen is inhibited from varying in the first electronic apparatus 4, the comparison result of the corresponding comparison circuit may be inverted, causing the exhausted battery not to supply power supply voltages to loads.

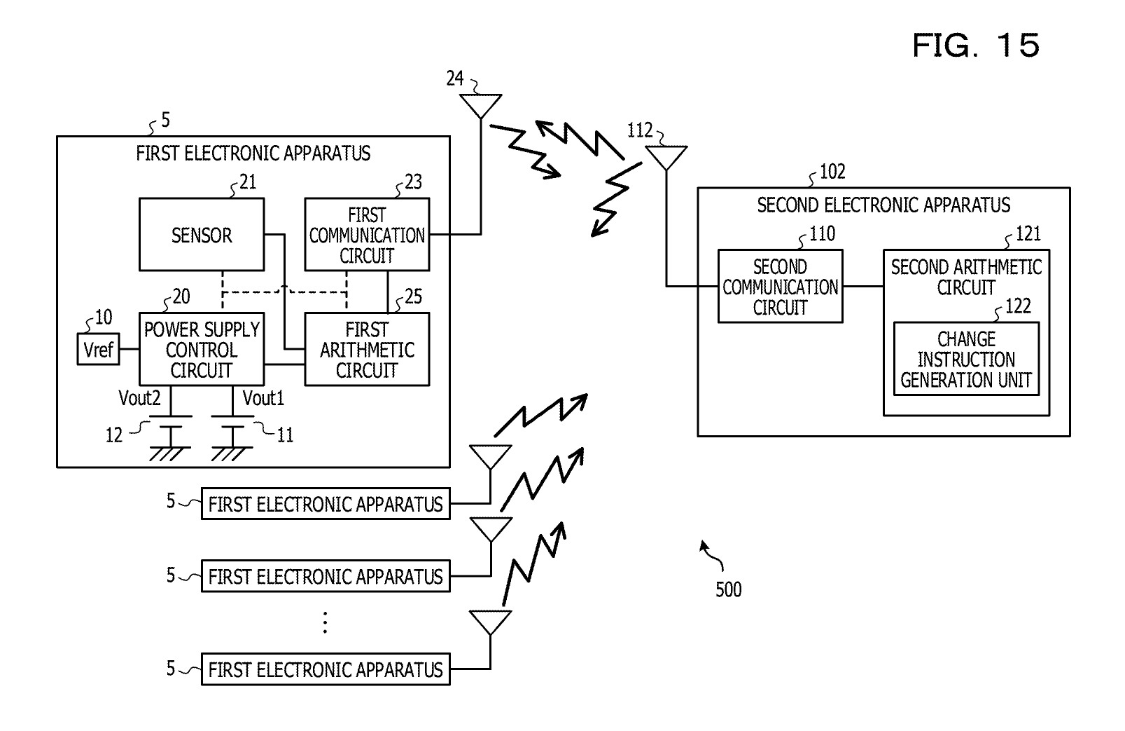

FIG. 15 illustrates an example of a control system including electronic apparatuses. In FIG. 15, signal lines are represented by solid lines and power supply lines are represented by broken lines.

A control system 500 differs from the control system 100 illustrated in FIG. 1 in that a plurality of first electronic apparatuses 5 are provided instead of the first electronic apparatus 1. Each of the plurality of first electronic apparatuses 5 differs from the first electronic apparatus 1 illustrated in FIG. 1 in that each first electronic apparatus 5 includes a first arithmetic circuit 25 instead of the first arithmetic circuit 22. The control system 500 differs from the control system 100 illustrated in FIG. 1 in that a second electronic apparatus 102 is provided instead of the second electronic apparatus 101. The second electronic apparatus 102 differs from the second electronic apparatus 101 illustrated in FIG. 1 in that the second electronic apparatus 102 includes a second arithmetic circuit 121 instead of the second arithmetic circuit 111. The configurations and functions of components of the control system 500 other than the first arithmetic circuit 25 and the second arithmetic circuit 121 are substantially the same as or similar to the configurations and functions of components of the control system 100 illustrated in FIG. 1 denoted by the same reference letters, and therefore detailed description thereof may be omitted.

The first arithmetic circuit 25 controls the sensor 21 based on sensor control information used for control over the sensor 21. The sensor control information includes the detection cycle of the sensor 21, the quantity of detection data provided by the sensor 21, and the number of detection data items provided by the sensor 21. The sensor control information includes the transmission cycle at which detection data provided by the sensor 21 is transmitted to the second electronic apparatus 102, and the transmission power used when detection data provided by the sensor 21 is transmitted to the second electronic apparatus 102. The detection cycle of the sensor 21 is a cycle at which the sensor 21 detects a target physical quantity. The quantity of detection data is the size of the detection data, and is, for example, the resolution of an image when the detection data is image data. The number of detection data items is the number of physical quantities, and the number of detection data items is, for example, three when the sensor 21 detects temperature, humidity, and precipitation.

When a change instruction for changing sensor control information is received from the second electronic apparatus 102, the first arithmetic circuit 25 changes the sensor control information in accordance with the change instruction.

The second arithmetic circuit 121 includes a change instruction generation unit 122. When a second battery selection signal indicating that the second battery 12 powers loads is received from the first electronic apparatus 5, the change instruction generation unit 122 generates a change instruction for changing sensor control information and transmits a change instruction signal indicating the generated change instruction to the first electronic apparatus 5. A change instruction generated by the change instruction generation unit 122 includes at least one out of lengthening the transmission cycle of the sensor 21 and the transmission cycle of detection data, reduction in the quantity of detection data and in the number of detection data items, and reduction in transmission power.

In the control system 100, the second electronic apparatus 102 transmits a change instruction for changing sensor control information including reduction in the quantity of detection data and in the number of detection data items to the first electronic apparatus 5 in response to receipt of a second battery selection signal indicating that the second battery 12 powers loads. In the control system 100, the second electronic apparatus 102 changes the sensor control information used for control over the sensor 21 so as to reduce the power consumption, when the second battery 12 functioning as an auxiliary power supply starts supplying power. This may result in extension of the lifetime of the second battery 12.

In each of the first electronic apparatuses 1 to 5, a comparison circuit determines whether or not the output voltage of a battery to be compared with a threshold is greater than or equal to the threshold; the comparison circuit may have a hysteresis characteristic. For example, in an electronic apparatus, a comparator with a hysteresis function may be used as a comparison circuit, or an external circuit for hysteresis may be added to the comparator.

The first electronic apparatuses 1 to 5 each include the sensor 21; however, an electronic apparatus according to an embodiment may not include the sensor 21. That is, an electronic apparatus according to an embodiment may be an electronic apparatus equipped with no sensor as long as the electronic apparatus is equipped with a plurality of batteries and a power supply control circuit for controlling switching between the batteries.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic apparatus comprising:
a load;
a first battery;
a second battery; and
a power supply control circuit configured to couple the first battery and the second battery to the load,
wherein the power supply control circuit includes:
a first switch including one end coupled to the first battery and the other end coupled to the load;
a second switch including one end coupled to the second battery and the other end coupled to the load; and
a first comparison circuit including a first input terminal coupled to an output terminal of the first battery and a second input terminal coupled to a threshold voltage and configured to control the first switch and the second switch based on a comparison result of an output voltage of the first battery and the threshold voltage and output a first battery selection signal indicating whether the first battery powers the load.

2. The electronic apparatus according to claim 1, wherein the first comparison circuit is configured to turn on the first switch, turn off the second switch and output the first battery selection signal indicating that the first battery powers the load when the output voltage of the first battery is greater than or equal to the threshold voltage, and the first comparison circuit is configured to turn off the first switch, turn on the second switch and output a second battery selection signal indicating that the second electronic battery powers the load, when the output voltage of the first battery is less than the threshold voltage.

3. The electronic apparatus according to claim 1, wherein the second battery has a smaller capacity than the first battery.

4. The electronic apparatus according to claim 1, further comprising:
a ground circuit configured to ground the output terminal of the first battery when the output voltage of the first battery is less than the threshold voltage.

5. The electronic apparatus according to claim 1, further comprising:
a threshold voltage generation circuit configured to generate the threshold voltage.

6. The electronic apparatus according to claim 5, wherein a power supply voltage of the threshold voltage generation circuit is an output voltage of the second battery.

7. The electronic apparatus according to claim 1, further comprising:
(N−2) batteries from a third battery to an Nth battery, N being an integer greater than or equal to three,
wherein the power supply control circuit is configured to couple the batteries from the third battery to the Nth battery to the load, the power supply control circuit further including:
(N−2) switches from a third switch to an Nth switch, each of the (N−2) switches including one end coupled to an output terminal of a corresponding one of the (N−2) batteries, and the other end coupled to the load,
(N−1) comparison circuits from a second comparison circuit to an Nth comparison circuit, each of the (N−1) comparison circuits including a first input terminal coupled to an output terminal of an Mth battery, M being an integer greater than or equal to two and less than or equal to N, and a second input terminal coupled to the threshold voltage and configured to output an Mth powerable signal indicating that the Mth battery coupled to the Mth switch is able to power the load when an output voltage of the Mth battery is greater than or equal to the threshold voltage and output an Mth non-powering signal indicating that the Mth battery coupled to the Mth switch does not power the load when the output voltage is less than the threshold voltage, and
(N−1) switch control circuits from a second switch control circuit to an Nth switch control circuit, each of the (N−1) switch control circuits including a first control terminal coupled to an output terminal of an (M−1)th comparison circuit and a second control terminal coupled to an output terminal of an Mth comparison circuit and configured to turn on the Mth switch and output an Mth battery selection signal indicating that the Mth battery is selected when the (M−1)th comparison circuit outputs an (M−1)th non-powering signal and the Mth comparison circuit outputs the Mth powerable signal, and turn off the Mth switch when the (M−1)th comparison circuit outputs an (M−1)th powerable signal and the Mth comparison circuit outputs the Mth non-powering signal.

8. The electronic apparatus according to claim 7, wherein the power supply control circuit further includes (N−1) ground circuits from a first ground circuit to an (N−1)th ground circuit, each of the (N−1) ground circuits being configured to ground an output terminal of a Qth battery, Q being an integer less than or equal to (N−1), when an output voltage of the Qth battery is less than the threshold voltage.

9. The electronic apparatus according to claim 7, further comprising a threshold voltage generation circuit configured to generate the threshold voltage from an output voltage of the Nth battery.

10. The electronic apparatus according to claim 9, wherein a power supply voltage of the threshold voltage generation circuit is the output voltage of the Nth battery.

11. A control system comprising:
a first electronic apparatus; and
a second electronic apparatus including a second communication circuit that is available for communication with the first electronic apparatus,
the first electronic apparatus including:
a load;
a first battery;
a second battery;
a power supply control circuit configured to couple the first battery and the second battery to the load and to output a battery selection signal indicating either the first battery or the second battery powers the load; and
a first communication circuit configured to transmit the battery selection signal to the second communication circuit,
wherein the power supply control circuit includes:
a first switch including one end coupled to the first battery and the other end coupled to the load;
a second switch including one end coupled to the second battery and the other end coupled to the load; and
a first comparison circuit including a first input terminal coupled to an output terminal of the first battery and a second input terminal coupled to a threshold voltage and configured to control the first switch and the second switch and output the battery selection signal, based on a comparison result of an output voltage of the first battery and the threshold voltage.

12. The control system according to claim 11, wherein
the first electronic apparatus further includes at least one sensor and a first arithmetic circuit configured to control the at least one sensor based on sensor control information used for control over the at least one sensor,
the second electronic apparatus further includes a change instruction generation unit configured to generate a change instruction for changing sensor control information, based on the battery selection signal received via the second communication circuit, and transmit a change instruction signal indicating the change instruction via the second communication circuit to the first communication circuit, and
the first arithmetic circuit is configured to change sensor control information in accordance with the change instruction corresponding to the change instruction signal received via the first communication circuit.

13. The control system according to claim 12, wherein the sensor control information includes at least one out of a detection cycle of the at least one sensor, a quantity of detection data detected by the at least one sensor, the number of items of the detection data, a transmission period during which the detection data is transmitted to the second electronic apparatus, and transmission power used when the detection data is transmitted to the second electronic apparatus.

14. A method for controlling an electronic apparatus, the method comprising:
turning on a first switch including one end coupled to a first battery and the other end coupled to a load and turning off a second switch including one end coupled to a second battery and the other end coupled to the load and outputting a first battery selection signal indicating that the first battery powers the load, when an output voltage is greater than or equal to a threshold voltage; and
turning off the first switch and turning on the second switch, and outputting a second battery selection signal indicating that the second battery powers the load, when the output voltage of the first battery falls below the threshold voltage.
